(19) United States
(12) Patent Application Publication
(10) Pub. No.: US 2013/0007319 A1
(43) Pub. Date: Jan. 3, 2013

(54) METHOD AND SYSTEM FOR IMPLEMENTING REDUNDANT NETWORK INTERFACE MODULES IN A DISTRIBUTED I/O SYSTEM

(75) Inventor: Bruce M. Decker, Barrington, NH (US)

(73) Assignee: SCHNEIDER ELECTRIC USA, INC., Palatine, IL (US)

(21) Appl. No.: 13/519,830

(22) PCT Filed: Dec. 27, 2010
(86) PCT No.: PCT/US10/62145

§ 371 Date: Sep. 17, 2012

(30) Foreign Application Priority Data
Dec. 31, 2009 (US) 12651290

(51) Int. Cl. G06F 13/36

(52) U.S. Cl. 710/110

(57) ABSTRACT

A method and system is disclosed for implementing redundant master NIMs (202, 204) on a single bus (106) in an industrial distributed I/O system (200) for controlling selected I/O modules (110, 112, 114). According to aspects of the invention, two master NIMs (202, 204) interoperate on a single bus (106), with one being the primary, active, master (202), and the second master (204) in a secondary, standby, mode, ready to assume mastership of the system if the primary master (202) is no longer active.

### FEDERALLY SPONSORED RESEARCH OR DEVELOPMENT

None.

### TECHNICAL FIELD

The present invention generally relates to distributed I/O systems in industrial automation networks. More specifically, the present invention relates to a method and system for implementing a redundant, standby master Network Interface Module on a single backplane bus in a distributed I/O system.

### BACKGROUND

Programmable controllers, such as programmable logic controllers (PLCs), can be used to monitor input signals from a variety of input points (i.e., input sensors) that report events and conditions occurring within a controlled process. For example, a PLC can monitor such input conditions as motor speed, temperature, pressure, volumetric flow and the like. The PLC has a control program stored within its memory to instruct the PLC on what actions to take upon encountering particular input signals or conditions. In response to these input signals provided by the input sensors, the PLC derives and generates output signals that are transmitted to control the process via PLC output points to various output devices such as actuators and relays. For example, an output signal can be provided by the PLC to speed up or slow down a conveyer, rotate the arm of a robot, open or close a relay, raise or lower temperature, as well as many other possible control functions.

The input and output points referred to above are typically associated with input modules and output modules, respectively. Input and output modules are collectively referred to as “I/O modules” herein. Those skilled in the art alternatively refer to such I/O modules as “I/O cards” or “I/O boards”. I/O modules are typically adapted to be plugged into respective slots located on a backplane board or other attachment system provided by the PLC. The slots are coupled together by a main bus that couples any I/O module plugged into the slots to a central processing unit (CPU). The CPU itself can be located on a card that is adapted to be plugged into a dedicated slot on the backplane board of the PLC.

In many control systems, PLCs are arranged in a master/slave network that includes a master PLC and a plurality of remote slave units that can include other PLCs or devices. In this type of a network, the master PLC controls its own I/O connection points and also the respective I/O connection points for the remote slave unit(s). The control commands from the master PLC are derived from data obtained from the remote slave units, which is obtained from the I/O module(s) connected to each remote slave unit.

To meet the needs of machine manufacturers and users, automation architectures have been decentralized or distributed while delivering performance comparable to centralized systems. For instance, the ADVANTYS™ STB distributed I/O system is an open, modular input/output system that makes it possible to design islands of automation managed by a master controller via a communication network, such as the Ethernet/IP fieldbus protocol. The ADVANTYS STB distributed I/O system is a product of Schneider Automation, One High Street, North Andover, Mass. (ADVANTYS is a trademark of Schneider Electric.)

These automation islands, typically installed close to the machine, help reduce the time and cabling cost for sensors and actuators, while increasing system availability. The island components are electronic modules mounted on one or more DIN rails (i.e., standardized rails). These clusters of modules, known as segments, carry a backplane bus from the beginning to the end of each island. The island bus provides power distribution, signal sensing, and power management to compatible modules.

An automation island can include one or more segments comprising a network interface module (NIM), a power distribution module (PDM), and additional modules for various architectures such as I/O modules, bus extension modules, island bus termination, and island bus extensions.

The island is typically configured using a user interface. The NIM is responsible for assigning addresses to the I/O modules and for maintaining a process image of the I/O modules. Both the NIM and the I/O modules can participate in I/O modules automatically obtaining their addresses based on their relative physical locations—using an auto-addressing protocol. The NIM is responsible for maintaining a process image of the I/O modules, which is based on the addresses of the I/O modules.

The NIM also represents a single point of failure on a distributed island implemented on a single bus. If a NIM fails or needs to be removed and replaced, all of the I/O modules associated with the NIM stop working, and as a consequence, any automated components controlled by the I/O modules essentially become disconnected. In networks such as industrial automation systems, reliability is critical. In a factory, for instance, if an I/O island goes down as a result of a NIM failure, the manufacturing line would stop and equipment could possibly be damaged. In such an environment, recovery of the failed NIM must be automatic and transparent.

Thus, there is a need for a method of providing automatic recovery for a NIM on a single-bus distributed I/O system, which can assume control of the island transparently to the I/O modules on the network.

### SUMMARY OF THE INVENTION

The invention described herein provides a method and system for implementing redundant NIMs as bus masters on a single-bus backplane network in a distributed I/O system. According to one embodiment of the invention, a first NIM initializes as a primary master NIM and a second NIM initializes as a secondary master NIM. The secondary NIM remains on the bus in standby mode and maintains a configuration file that is continuously synchronized with the primary NIM's configuration file. Thus, if the primary NIM surrenders control, fails, or must be taken offline, the secondary NIM can immediately assume mastership of the system transparently to the I/O modules being controlled, i.e., a “bumpless switchover”.

According to another embodiment of the invention, a secondary NIM may initialize as the acting primary master NIM if the secondary NIM determines that a primary NIM has failed to initialize. When the original primary NIM is able to initialize, the original primary NIM can serve as the acting redundant NIM in case the acting NIM device fails.

In accordance with the invention, a distributed I/O system is provided for an industrial automation environment, comprising: at least one I/O module; a first network interface module (NIM) coupled to the I/O module via a single bus network and adapted to convert the information provided from the I/O module to another format to be provided to an upstream controller, the first NIM adapted to serve as a primary master NIM on the bus; and a second NIM coupled to the I/O module and the first NIM via the single bus network and adapted to convert the information provided from the I/O module to another format to be provided to an upstream controller, the second NIM adapted to serve as a secondary master NIM on the bus, and further adapted to assume mastership of the bus without resetting the system upon failure of the primary master NIM. The initialization of the second NIM as the new primary master NIM on the bus is a bumpless transfer of control, as both the primary NIM and the second NIM remain in continuous synchronization throughout normal operation of the system.

According to another aspect of the invention, a method of implementing redundant network interface modules (NIMs) on a single bus in a distributed I/O system is provided for an industrial automation environment, the system having a first and second NIM and an I/O module connected to the bus, the method comprising the steps of: (a) determining at the first NIM that the first NIM is a primary master NIM on the bus; (b) determining at the second NIM that the second NIM is a secondary master NIM on the bus; (c) maintaining synchronized device configurations between the first and second NIMs in real time; (d) determining at the secondary NIM that the primary master NIM is no longer active; and (e) assuming mastership of the bus by the second NIM without resetting the system bus. As a bus reset communications command is not issued and the devices on the bus are not re-booted upon the second NIM assuming mastership of the bus, the switchover comprises a bumpless transfer from the primary master NIM to the secondary master NIM.

### BRIEF DESCRIPTION OF THE DRAWINGS

The present invention is illustrated by way of example in the following figures and is not limited by the accompanying figures in which:

FIG. 1A depicts a single-NIM distributed I/O system with a single-bus backplane in accordance with the prior art.

FIG. 1B depicts the configuration of an exemplary NIM of FIG. 1A according to the prior art.

FIG. 2 depicts an exemplary distributed I/O system with a single-bus backplane in which an embodiment of the present invention may be performed.

FIG. 3 depicts a normal startup sequence of redundant NIMs according to techniques described herein.

FIG. 4 depicts a primary NIM failure sequence according to techniques described herein.

FIG. 5 depicts a primary NIM failure sequence at startup according to techniques described herein.

### DETAILED DESCRIPTION OF THE INVENTION

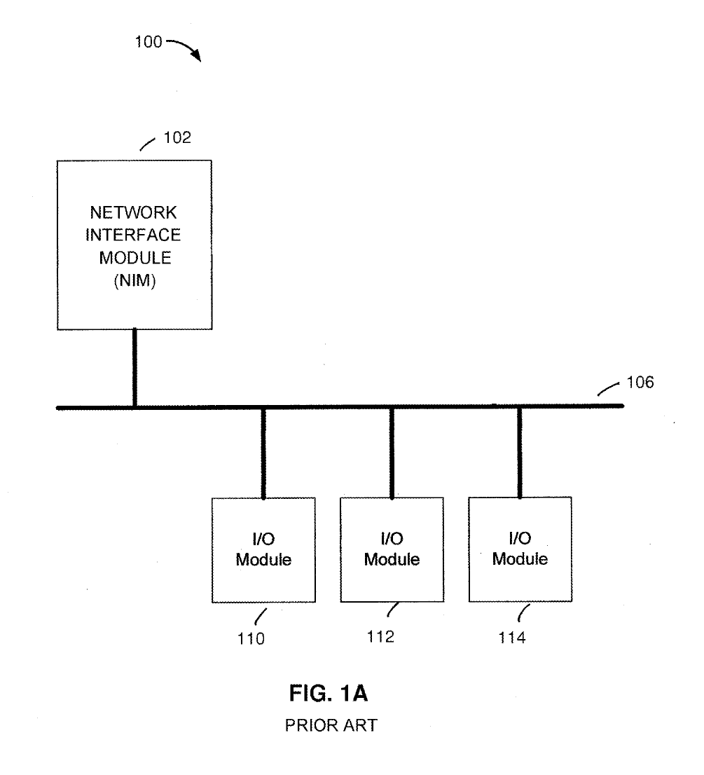

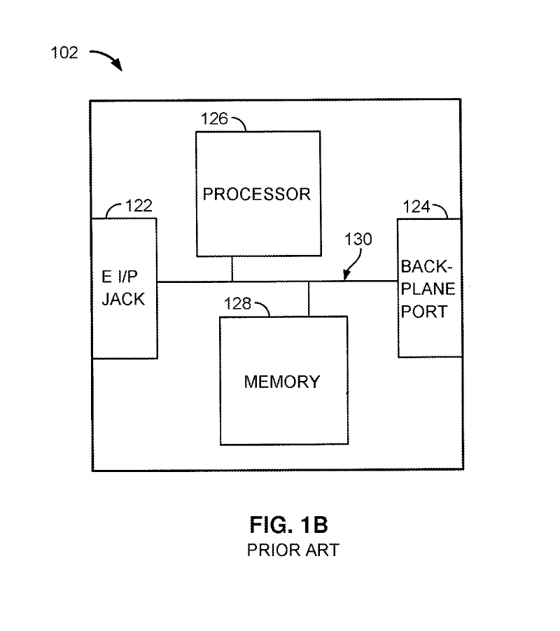

FIG. 1A depicts a distributed I/O system 100 in accordance with the prior art, as typically found in an industrial automation facility. System 100 includes a single network interface module or NIM 102. A PLC upstream (not shown) is connected to and communicates with the NIM 102 via a fieldbus. The single NIM 102 is connected to and communicates on its backplane via the single-bus network 106. Network 106 may be implemented using any appropriate bus protocol, including the well-known CANopen protocol. Input/Output or I/O modules 110, 112, and 114 are also connected to the backplane bus 106 and are able to communicate with the NIM 102 over bus 106. There may be more or less than three I/O modules, depending on the specific automation environment being implemented.

As is also known in the art, NIM 102 may be implemented with a variety of conventional components such as shown in FIG. 1B. NIM 102 includes at least an Ethernet I/P jack 122 on the front of the NIM to communicate with the PLC, and a backplane port 124 on the back of the NIM for receiving and sending data traffic. NIM 102 further includes at least a central processor 126, a system memory 128, and a system bus 130 that couples the various system components including jacks/ports 122 and 124, central processor 126 and the system memory 128. System bus 130 may be any of several types of bus structures including a memory bus or memory controller, a peripheral bus, and a local bus using any of a variety of bus architectures. The structure of system memory 128 is well known to those skilled in the art and may include a basic input/output system (BIOS) stored in a read-only memory (ROM) and one or more program modules such as operating systems, application programs and program data stored in random-access memory (RAM). Furthermore, NIM 102 may include drives for interfacing with other types of computer readable media.

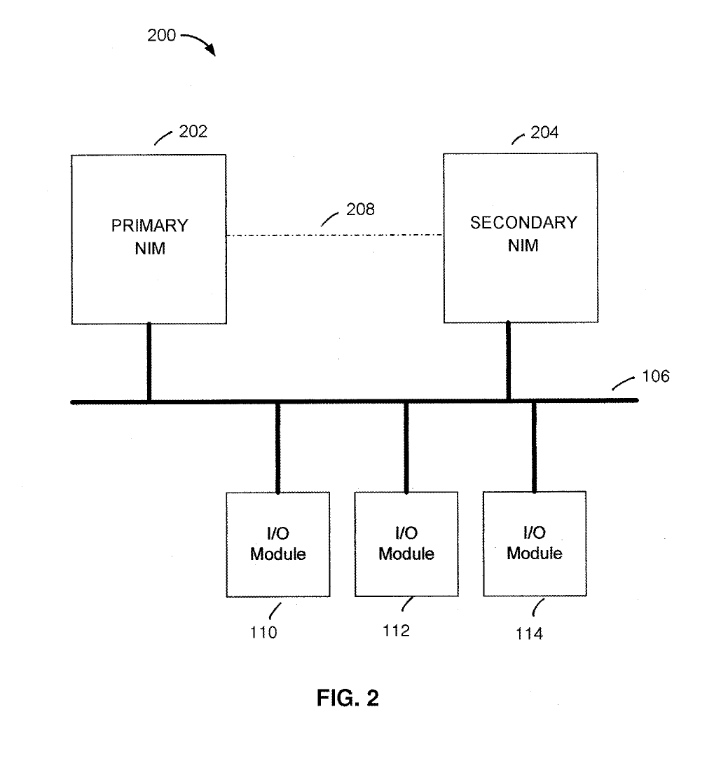

In contrast to the single-NIM configuration of FIG. 1A, aspects of the present invention provide a method and system for implementing a redundant NIM in a distributed control system, such as an industrial automation network. FIG. 2 depicts an exemplary single-bus network on which an embodiment of the invention may be performed. Distributed I/O system 200 includes both a primary NIM 202 and a redundant or secondary NIM 204. The primary NIM 202 and the secondary NIM 204 are both connected to and communicate via the single-bus network 106 on the backplane of the system 200. As will be explained in detail below, according to one embodiment of the invention, the primary NIM 202 initializes as a primary backplane master NIM, and the secondary NIM 204 also initializes as a secondary backplane master NIM, but in a secondary or standby mode, ready to assume mastership of the system 200 if the primary master NIM 202 fails.

In FIG. 2, backplane network 106 may be implemented using any bus protocol, including the CANopen protocol. I/O modules 110, 112, and 114 are also connected to the backplane bus 106 and are able to simultaneously communicate with the primary NIM 202 and the secondary NIM 204 over bus 106. There may be more or less than three I/O modules, depending on the specific automation environment being implemented. In addition, according to an embodiment of the invention, there may be a second communication link 208 between the primary NIM 202 and the redundant NIM 204. The second communication link 208 may be implemented using a network technology such as Ethernet and may be used for synchronization and other communication directly between the two NIMs 202 and 204 separate from the backplane network 106.

Those skilled in the art will recognize that a fieldbus network is a control and/or computer network that may be used in industrial automation and process control systems. CANopen is a protocol that is often used for communication in distributed control systems. The CAN in Automation (CiA) non-profit organization publishes standards that are used in the Automation industry for the implementation of the CANopen protocol. The CANopen addressing techniques and standards referenced herein are further described in the CAN in Automation (CiA) Draft Standard CiA 301. Those skilled in the art will further recognize that aspects of the invention may be implemented using other network protocols that support networks which are physically or logically structured as a bus, i.e., networks where every node must listen to all messages exchanged on the network. Examples of other network protocols that may be used to implement aspects of the invention include DeviceNet and J1939, or other CAN-based protocols, protocols based on EIA 485, e.g., Modbus serial (Modbus is a registered trademark of Schneider Electric), and Actuator Sensor interface (ASi).

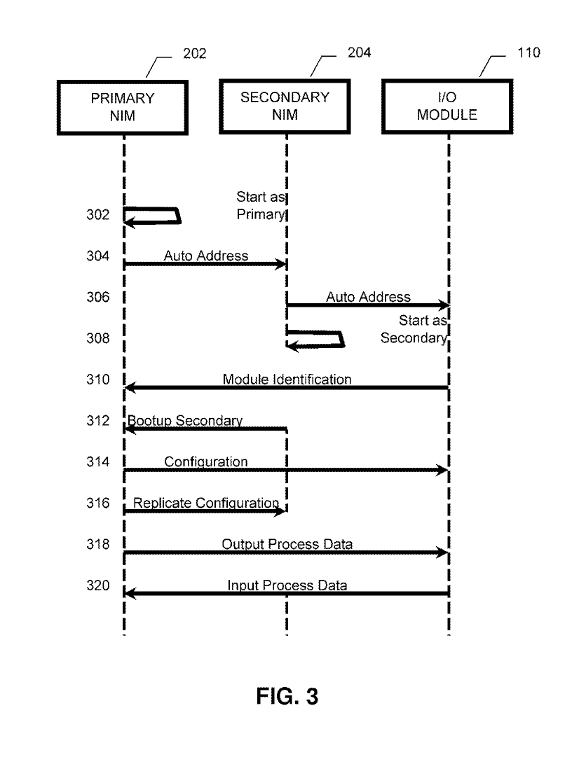

FIG. 3 depicts a normal start-up sequence for a redundant NIM, according to one embodiment of the present invention. In FIG. 3, NIM 202 sits to the left (upstream) of NIM 204 on the bus and thus serves as the primary NIM. NIM 204 serves as the secondary or redundant NIM. As depicted in FIG. 3, devices 202 and 204 may control I/O module 110, positioned further to the right (downstream) of the secondary NIM 204 on the bus. According to the embodiment depicted, the primary NIM 202 initializes when it receives an external logical low signal at event 302, instructing it to initialize as the primary NIM on the bus. This external signal may come from a higher-order controller, such as a PLC or other device attached to NIM 202, as part of the distributed I/O system. Initialization of the primary NIM may also be implemented as a grounded auto-address message to its left, letting the primary NIM know that it is the left-most device on the bus and thus, according to one embodiment, will act as the primary NIM.

After initialization, the primary NIM may begin sending auto-address messages at event 304 to the remaining devices to the right (downstream) of the primary NIM on the bus. When the secondary NIM 204 sees a positive auto-address message upstream on the bus at event 304, the right NIM 204 passes the message to downstream I/O modules at event 306 and also knows to initialize itself as a secondary NIM on the bus at event 308. Alternatively, the secondary NIM 204 may initialize upon receipt of an external logical high signal, instructing it to boot-up as a secondary NIM on the bus. After initializing as the redundant NIM, secondary NIM 204 may listen to messages sent and received by the primary NIM 202 and the I/O modules. These messages are shown in FIG. 3 as Output process data at event 318 and Input process data at event 320. The redundant NIM 204 can forward traffic on the bus and may also save information contained in the messages (such as address information regarding the I/O modules) to keep a real time configuration file. Bus traffic may also include identification of the I/O modules, such as a CANopen module identification message sent from identifying I/O module 110 at event 310. Also upon initialization, the secondary NIM 204 may inform the primary NIM 202 of its presence on the bus by sending a boot-up message at event 312, such as a CANopen boot up message, which may also relay a unique node address for the secondary NIM 204.

According to techniques of the present invention, the primary NIM 202 and secondary NIM 204 each have two distinct addresses, i.e., a shared node address and a unique node address. If implemented according to the CANopen protocol, the NIMs 202 and 204 may share NIM node address 127, and the NIMs may also each have a unique node address, node address 125 and node address 126, respectively. This addressing scheme helps the primary and redundant NIMs accomplish transparent or “bumpless” transfer of control, as described below.

The methodology described above takes advantage of aspects of a backplane bus network. While only one NIM can be in control of the bus at a given time (i.e., mastership), both NIMs have the capability (and obligation, if implemented using the CANopen protocol) to listen to the bus traffic. This allows both NIMs, which have identically configured input object dictionaries, to maintain synchronized dictionaries in real time. In other words, in a preferred embodiment, both the primary NIM 202 and the secondary NIM 204 remain in continuous synchronization with each event of bus traffic.

Aspects of the invention further provide for maintaining identical configuration files on the primary and secondary NIMs 202 and 204 through replication. While both NIMs may be listening on the bus simultaneously, and therefore able to maintain current configuration files independently, a separate communication link between the NIMs allows for the primary NIM 202 to send a copy of a configuration file, including all object dictionaries, to the secondary NIM 204. Referring back to FIG. 3 at event 316, the primary NIM 202 may replicate its configuration over the separate communication link 208 or over the backplane bus 106. However, replication of the configuration file may also occur externally. For example, in a fieldbus network implemented using the Ethernet/IP protocol, a NIM may be receiving commands from a higher-order controller, such as a PLC. In such a case, both the primary and secondary NIMs may receive output commands simultaneously from this external controller, for synchronization.

According to techniques described herein, different methods may be used to transfer control from the primary NIM to a secondary NIM. According to one embodiment, the primary NIM may send a message to the secondary NIM to cede control if the primary NIM knows it is going to be taken down. In the case of a sudden failure, however, the primary NIM may not be able to send such a message, and the foregoing techniques may be employed.

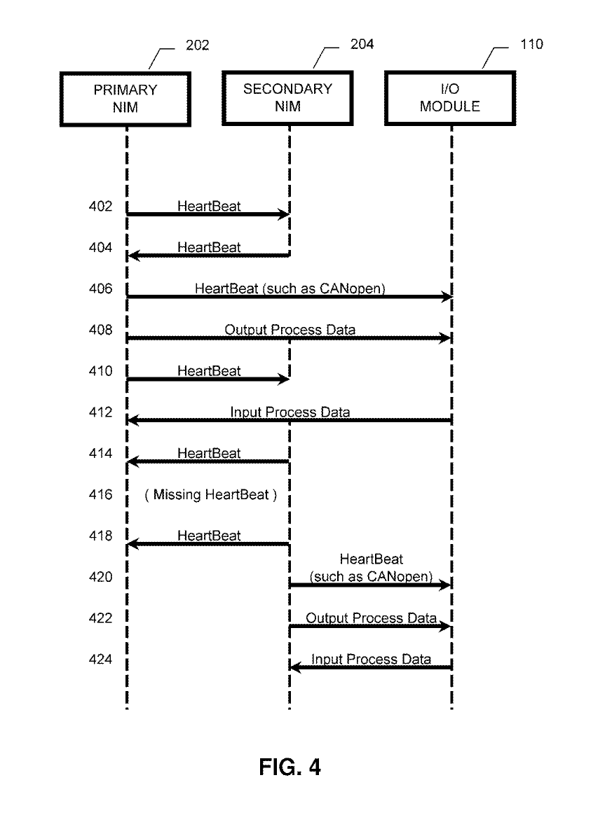

In another embodiment, the CANopen or other protocol heartbeat message capability may be used to determine if a primary NIM is no longer available and a secondary NIM should assume the mastership of the bus. FIG. 4 depicts how a secondary NIM 204 may assume mastership on the bus when the primary NIM 202 fails or is taken offline. According to this embodiment, NIMs 202 and 204 exchange heartbeat messages, shown at events 402 and 404, using their own distinct unique node addresses. To prevent false trips during times when the bus is busy, however, the heartbeat between the NIMs need only be transmitted by the secondary NIM 204 on schedule, because if the primary NIM 202 is transmitting CANopen messages, such as the CANopen heartbeat message at event 406 to the I/O modules, the secondary NIM 204 knows the primary NIM is alive. If the primary NIM does not have any other messages to transmit for a specified interval, however, the primary NIM 202 may transmit a heartbeat message to the secondary NIM 204 to announce it is still alive. For example, according to the embodiment of FIG. 4, the primary NIM 202 transmits a CANopen heartbeat message at event 406, transmits Output process data at event 408, and then sends a heartbeat message between NIMs at event 410. The primary NIM 202 periodically receives Input process data, shown as event 412. The secondary NIM 204 returns the heartbeat message at event 414 and waits for a subsequent message from the primary NIM 202.

When the secondary NIM 204 does not receive a heartbeat message or other message from the primary NIM 202 at event 416, the secondary NIM 204 can immediately assume mastership of the bus. The secondary NIM 204 may then assume transmission of the CANopen heartbeat messages at event 418 or other heartbeat messages at event 420 to the I/O modules on the bus. According to the embodiment of FIG. 4, to achieve transparency, the interval between heartbeat messages sent between the NIMs may be faster than the CANopen heartbeat messages sent to the I/O modules so that the secondary NIM can assume mastership before the I/O modules fail. This NIM changeover is truly “bumpless”, i.e., the disconnection of the primary NIM and the connection of the secondary NIM to replace the primary unit is performed in such a way that it does not affect the behavior of the distributed I/O system other than possibly by a short time delay introduced in a currently executing operation. There was no need to re-boot and re-initialize the system, or to force a master reset of the communication network, or to shut down the operation of the backplane bus 106. (As used herein, “re-boot” includes a “warm boot” procedure.) The upstream PLC would not even have to know the transfer occurred, and the transfer of data from the downstream I/O modules would not have been disturbed. Operation of the distributed I/O system continues uninterrupted with secondary NIM sending Output process data at 422 and receiving Input process data at 424.

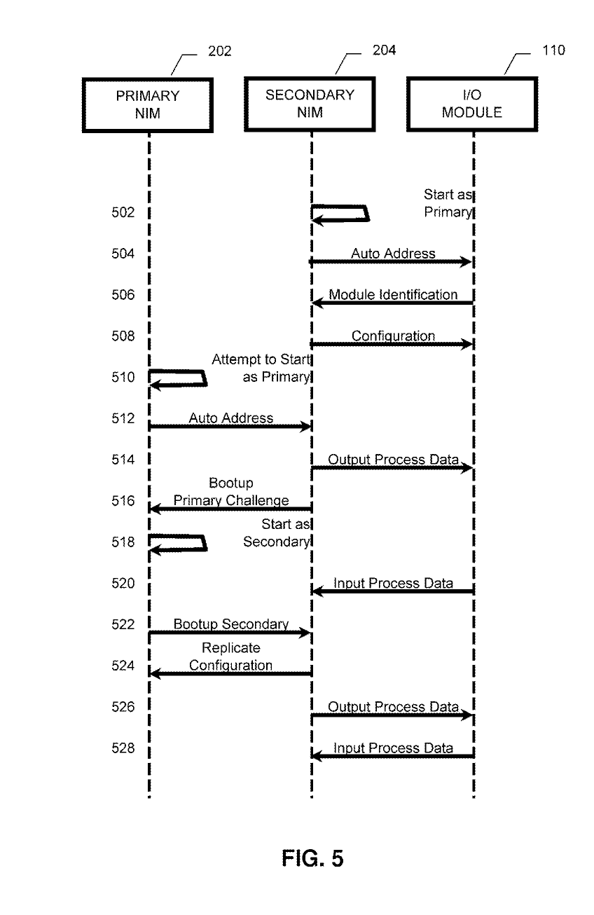

FIG. 5 depicts an abnormal startup scenario according to another embodiment of the invention. In the example of FIG. 5, the intended primary NIM 202 (on the left) fails to initialize, so after a specified time interval, the secondary NIM 204 (on the right) initializes as the primary NIM at event 502. After initialization, the secondary NIM 204 acts as the sole NIM in the system for a period of time, performing Auto Address, Module Identification, and Configuration at events 504-508. After the secondary NIM 204 has already initialized as the primary NIM, the left NIM 202 attempts to initialize as a primary NIM at event 510, and sends a standard auto address message at event 512. According to this embodiment, when the right NIM 204 (the acting primary NIM) detects the left NIM's presence, the right NIM 204 sends a boot-up primary challenge to the left NIM 202, by sending a CANopen boot-up message at event 516 using address 127, for example. In this scenario, when the right NIM 204 uses the NIM node address 127 for the boot-up message challenge, and not its secondary unique address of 126, the left NIM 202 understands that it must initialize as the redundant secondary NIM at event 518, and not as the primary NIM. Once the left NIM is ready to be synchronized, it sends a boot-up secondary message at event 522 (with its secondary node address) to the right NIM 204. At event 524, the NIMs may synchronize their device configurations using one of the techniques previously described so that the two NIMs have identically configured object dictionaries. Throughout this startup procedure, the right NIM 204 maintains primary mastership of the bus and performs the Output process data and Input process data functions at events 514, 520, 526, and 528, while the left NIM 202 remains in a secondary or redundant role.

This invention provides an additional advantage in that a process controller, such as a PLC, which is requesting input data and controlling output data on distributed I/O system 200, does not need to be programmed to intervene when the primary NIM fails or when the secondary NIM assumes mastership from the primary NIM. Other than a potential awareness of an alarm message from the secondary NIM indicating it has assumed mastership of the backplane, the PLC control logic is not burdened with managing the switchover. Furthermore, the redundant NIM implementation of the present invention does not require the PLC to have any additional software or special configuration to manage or adapt to the switchover. Another advantage is that since the two NIMs have identically configured object dictionaries, there is no additional effort required to configure either NIM specifically for the primary or secondary role. According to aspects of the invention described herein, the transition from a primary NIM to a secondary NIM should be bumpless or transparent to the attached I/O modules, which inherently means that the communications bus cannot be temporarily shut down as would otherwise be required by a reset communication command or a re-boot procedure.

Those skilled in the art will recognize that the foregoing techniques may be implemented on a variety of bus-based networking systems and with a variety of transmission media. Networks based on wire, fiber optic cable, wireless or other transmission media may utilize the present invention. It should be further noted that certain aspects of the present invention have been described herein, but the invention is not limited to the embodiments described. Those skilled in the art will recognize additional variations embodied by the present invention upon reading or upon practice of the invention. The following claims demonstrate the breadth of the invention.

I claim:

1. A distributed I/O system for an industrial automation environment, comprising:
at least one I/O module;
a first network interface module (NIM) coupled to the I/O module via a single bus network and adapted to convert the information provided from the I/O module to another format to be provided to an upstream controller, the first NIM adapted to serve as a primary master NIM on the bus;
a second NIM coupled to the I/O module and the first NIM via the single bus network and adapted to convert the information provided from the I/O module to another format to be provided to an upstream controller, the second NIM adapted to serve as a secondary master NIM on the bus, and further adapted to assume mastership of the bus without resetting the system upon failure of the primary master NIM.

2. The distributed I/O system according to claim 1, wherein the second NIM is adapted to initialize as a secondary master NIM on the bus, and to transmit a message to the primary master NIM regarding its presence on the bus.

3. The distributed I/O system according to claim 2, wherein the second NIM is further adapted to determine if the first NIM is no longer active, and based on such determination, initialize as the new primary master NIM on the bus.

4. The distributed I/O system according to claim 3, wherein the initialization of the second NIM as the new primary master NIM on the bus is a bumpless transfer of control.

5. The distributed I/O system according to claim 1, wherein both the first NIM and the second NIM remain in continuous synchronization throughout normal operation of the system.

6. A network interface module (NIM) for a distributed I/O system in an industrial automation environment and adapted for use with another NIM as redundant NIMs, wherein the distributed I/O system is implemented on a single bus with both NIMs adapted as master NIMs coupled to at least one I/O module via the bus, the NIM comprising:
a processor;
a memory coupled to the processor, wherein the memory contains computer-executable instructions to perform the acts of:
(a) initializing the NIM as a secondary NIM on the bus;
(b) transmitting a message to the primary NIM regarding its presence on the bus;
(c) maintaining a synchronized device configuration with the primary NIM in real time;
(d) determining that the primary NIM is no longer active; and
(e) based upon such determination, initializing as a new primary master NIM on the bus without resetting the system.

7. The NIM of claim 6, wherein the memory further contains computer-executable instructions to perform the act of replicating the configuration of the primary NIM.

8. The NIM of claim 7, wherein replicating the primary NIM configuration comprises synchronizing a configuration file over a separate communication link between the primary NIM and the secondary NIM.

9. The NIM of claim 6, wherein the bus uses the CANopen protocol.

10. The NIM of claim 6, wherein the NIM is positioned to the right and downstream of the primary NIM on the bus.

11. The NIM of claim 6, wherein act (d) comprises determining that the primary NIM is no longer transmitting messages on the bus, wherein the messages include CANopen heartbeat messages.

12. The NIM of claim 6, wherein the initializing in act (e) comprises a bumpless switchover from the primary NIM.

13. A method of implementing redundant network interface modules (NIMs) on a single bus in a distributed I/O system in an industrial automation environment, the system having a first and second NIM and an I/O module connected to the bus, the method comprising the steps of:
(a) determining at the first NIM that the first NIM is a primary master NIM on the bus;
(b) determining at the second NIM that the second NIM is a secondary master NIM on the bus;
(c) maintaining synchronized device configurations between the first and second NIMs in real time;
(d) determining at the second NIM that the primary master NIM is no longer active; and
(e) assuming mastership of the bus by the second NIM without resetting the system bus.

14. The method of claim 13, wherein the bus is a CANopen bus located on the backplane of the distributed I/O system.

15. The method of claim 13, wherein in step (c) further comprises replicating the first NIM configuration on the second NIM via a separate communication link.

16. The method of claim 13, wherein step (d) includes determining at the second NIM that the primary master NIM is no longer transmitting messages on the bus.

17. The method of claim 16, wherein the messages are CANopen heartbeat messages.

18. The method of claim 13, wherein the first NIM and the second NIM each have two distinct addresses on the bus, and one of the distinct addresses for the first NIM is the same as one of the distinct addresses for the second NIM, and one of the distinct addresses for the first NIM is different than one of the distinct addresses for the second NIM.

19. The method of claim 13, wherein a bus reset communications command is not issued and the devices on the bus are not re-booted upon the second NIM assuming mastership of the bus.

20. The method of claim 13, wherein step (e) comprises a bumpless transfer from the primary master NIM to the secondary master NIM.
